(19) United States
(12) Patent Application Publication
(10) Pub. No.: US 2013/0007621 A1
(43) Pub. Date: Jan. 3, 2013

(54) SYSTEM FOR LEARNING NAMES OF MEMBERS OF AN ORGANIZATION

(76) Inventor: Brian Warren, Palm Beach Gardens, FL (US)

(21) Appl. No.: 13/174,106

(22) Filed: Jun. 30, 2011

(51) Int. Cl. G06F 3/048

(52) U.S. Cl. 715/733

(57) ABSTRACT

A system for learning the names and information about individual members of a group includes a server. A database is in communication with the server and stores the names and likenesses of a first group of individuals. Names and job types of a second group of individuals is stored in the database and the server associates respective members of the first group of individuals with respective individuals of the second group of individuals as a function of the job type of the second group of individuals. A remote computer is in communication with the server. The server causes the display of the associated member of the first group to the respective member of the second group at the remote computer. The remote computer has a graphical user interface. The server causes the name and the likeness of two or more individuals of the first group to be displayed at the remote computer. The remote computer enables the user to graphically match a name of at least one individual in the first group to a likeness of any one of the displayed individuals.

### BACKGROUND OF THE INVENTION

This invention is directed to a system to train a user, across a distributed network, to memorize facts, and more particularly, to associate the names and faces of members of a group for later use.

In the service industry, a desired part of the service is to personalize the service, i.e. individualize the service so that the service provider makes the person receiving the service feel special. One way in which to accomplish this is to make sure that the recipient of the service perceives the fact that the provider of the service does not treat the person receiving the services as a commodity. This can be done by insuring that the service provider recognizes the individual as an individual, including recognizing specific characteristics, needs or history about that individual. In a club setting, such as a private social club, a private gym membership, or even a country club, this facet of the service becomes even more of a necessity.

Service staff at a facility such as a country club has been encouraged in the past to learn the names of the members of the club. However, this has been done in the same archaic way for decades. Name and face recognition can occur over time from exposure of the service provider to the group to whom they are providing the service. This has been satisfactory, however, it puts new employees or new service providers at a true disadvantage, and lowers the overall level of service as the staff must wait for the new members to rise to the common level of expected service. It has also been known to use photographs such as of club events, from club directories or the like to teach new staff the names and faces of club members. However, this process suffers from the disadvantage that club directories are fixed in time and therefore, do not provide the flexibility of adding pertinent information as it becomes known, or reflecting any changes in club membership; including intervening additions or subtractions.

A further deficiency of the prior art, is that as a function of the job being performed, such as kitchen staff versus golf pro, versus tennis as compared to tennis pro, each service provider only needs to learn a subset of the entire group of members as they do not necessarily interact with all members. Accordingly, another deficiency of the prior art is that it requires the same level of memorization and work for each service provider regardless of the amount of individuals they are actually required to know in order to provide a sufficient level of service. Accordingly, a system for overcoming the shortcomings of the prior art is desired.

### SUMMARY OF THE INVENTION

A system for learning the names and likeness information about individual members of a group includes a server. A database is in communication with the server and stores the names and likenesses of a first group of individuals. Names and job types of a second group of individuals is stored in the database. The server associates respective members of the first group of individuals with respective individuals of the second group of individuals as a function of the job type of the second group of individuals. A remote computer is in communication with the server. The server causes the display of the likeness information of associated member of the first group to the respective member of the second group at the remote computer. The remote computer has a graphical user interface. The server causes the name and likeness information of at least one individual of the first group to be displayed at the remote computer. The remote computer enables the user to graphically match a name of at least one individual in the first group to a likeness of any one of the displayed individuals.

### BRIEF DESCRIPTION OF THE DRAWINGS

The present disclosure would be better understood by reading the written description with reference to the accompanying drawings, in which reference numerals denote the similar structure and refer to like elements throughout and which:

FIG. 1 is a block diagram of a distributed network system operating in accordance with the invention;

FIG. 2 is a flow chart for the method of operation of the system to learn names in accordance with the invention;

FIG. 3 is a screen shot of a graphical user interface for one embodiment of the invention;

FIG. 4 is a screen shot of a graphical user interface in accordance with another embodiment of the invention; and

FIG. 5 is a screen shot of a graphical user interface in accordance with yet another embodiment of the invention.

### DETAILED DESCRIPTION OF THE PREFERRED EMBODIMENT

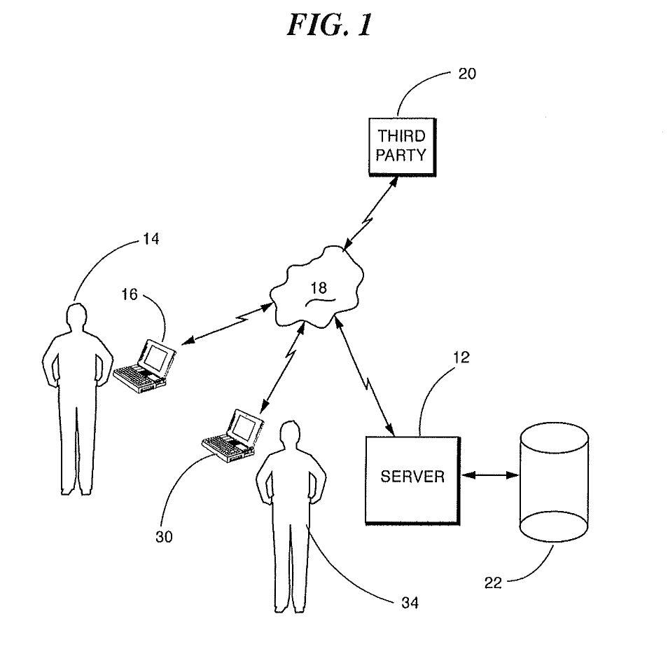

Reference is had to FIG. 1 in which a system, generally indicated as 10, is provided which enables a user 14, such as a service provider or employee, to learn information, including the name and likeness of a member of a first group as a function of a service provided by user 14 to that group. System 10 includes a server 12 operatively communicating with a database 22. Server 12 communicates with the first user 14 through a first computer 16 through internet 18. Server 12 may also communicate with a second user 34 through a second computer 30 through Internet 18. Server 12 may also communicate with third party databases 20, such as a directory database, a social media database having the members of a group therein or the like.

In a preferred embodiment, server 12 provides an interactive web base portal such as a web page for interacting with user 14 or user 34. However, it should be noted that computers 16, 30 may be any interactive device which allows each of first user 14, second user 34 and/or third party 20 to interact with each other utilizing the functionality described below. It should be noted that the preferred embodiment is an internet based system to facilitate the use of server 12 and third party database 20 with its associated servers. However, the computing device may be anything having a graphical user interface and display capable of communicating graphical inputs utilizing either the Internet, telephone, cable TV, hand held personal data accessories or smart cellular phones by way of nonlimiting example.

Database 22 stores data about members of the group to whom a service is provided. These members form a first group of individuals stored in the database. Along with the names of the members of the group, information such as the likeness (photograph) and likes (the manners in which they use the service) are stored. The members of the first group may be further grouped as subgroups as a function of the use of which they make of the service. By way of example, in a country club setting, certain users make use of all the facilities, others are social members utilizing only the food facilities, while still others only make use of the golf facilities and/or tennis facilities. The members of the first group may be subgrouped as a function of this use and either mapped to each other utilizing tags and objects or stored as such groups. It is well within the scope of the invention that certain members may belong to two or more subgroups.

Database 22 may also store information about service providers who provide service to the members of the first group. Database 22 may store information such as name, employee ID and job responsibility. The job responsibility information may include identifiers such as wait staff and banquet hall, reception, tennis pro, golf pro shop attendee or golf shop. This information may also be stored at a third party server 20 such as the computer system of the facility to which the first group and second group are affiliated, such as a golf club in our nonlimiting exemplary embodiment.

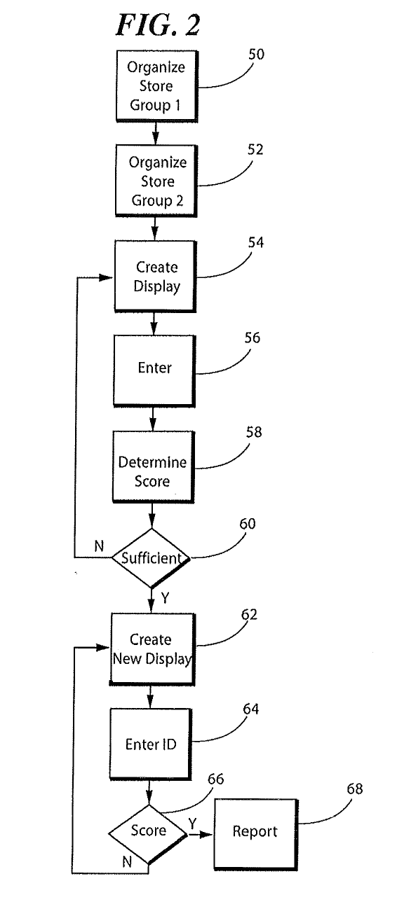

Reference is now made to FIGS. 2-5 in which a flow chart and screen shots for operation of the system 10 is provided.

In a step 50, a supervisor 34 at a second computer 30 inputs data about the members of the first group. Membership data includes names, photos and membership type. They are either directly input manually at computer 34 or may be downloaded from a third party database 20 such as the club membership database or point of sale system or the like. As discussed, members of the first group are organized into subgroups according to their status, membership type or activity. Members may be assigned rankings as a matter of status, such as officers of the club, member of the year (which often comes with preferred parking or some other perk) or access to certain facilities.

A second group of individuals, employees, in this example, are organized and stored at database 22 by supervisor 34 either manually at computer 30 or utilizing some other third party database 20 and stored in database 22 as a second group of individuals. Employees are assigned unique user names and passwords as well as the type of service provided as an alpha numeric code. Server 12 matches members of the second group to members of the first group as a function of membership type or activity of members of the first group and a particular employee as a function of the membership type or activity of the member and the service provider code of the employee. In this way, server 12 prioritizes the information which the employee must master in order to provide the desired level of service.

During use, server 12 creates a display at either one of computer 30 or 16 where an employee 14 interacts with computer 16 in this example through a graphical user interface. As a function of user 14 identifying themselves, server 12 selects at random likeness information, including images of users, such as members of the first group, to be displayed at computer 16 in a step 54. Server 12 provides at least two images and at least one name information to be displayed at computer 16 in accordance with step 54. At least one of the two or more likenesses corresponds to the name.

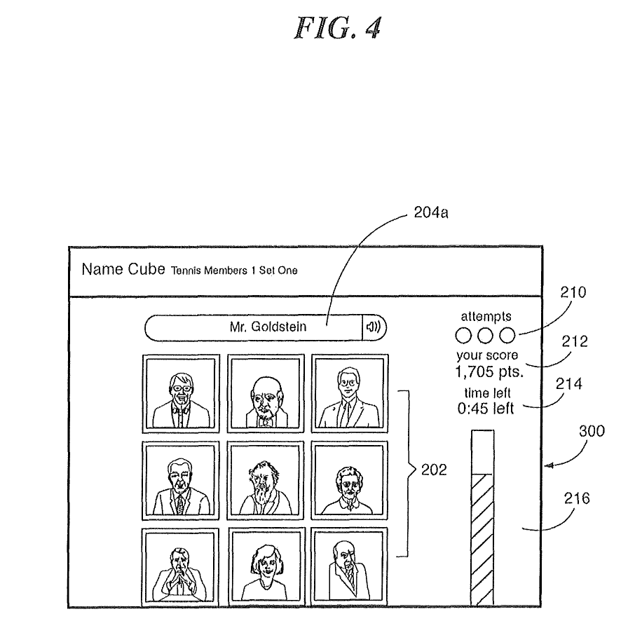

In a preferred embodiment as shown in FIG. 4, a screen 300 which is a graphical user interface as well, displays a name 204 and images 202 of members of the first group. In this embodiment, there are more images 202 than names 204, but the invention may also include the inverse relationship. In a step 56, user 14 utilizes the graphical user interface associated with computer 16. User 14 selects the image 202, which user 14 believes is associated with the name information 204. Server 12 determines whether the election is a correct match and keeps a running score of correct answers for the user 14 during use. Server 12 will provide successive pairings of at least one name information and at least two or more likeness information at computer 16 for a predetermined time period or until a predetermined number of matches have been offered to provide a significant sample size to determine whether user 16 has mastered the information.

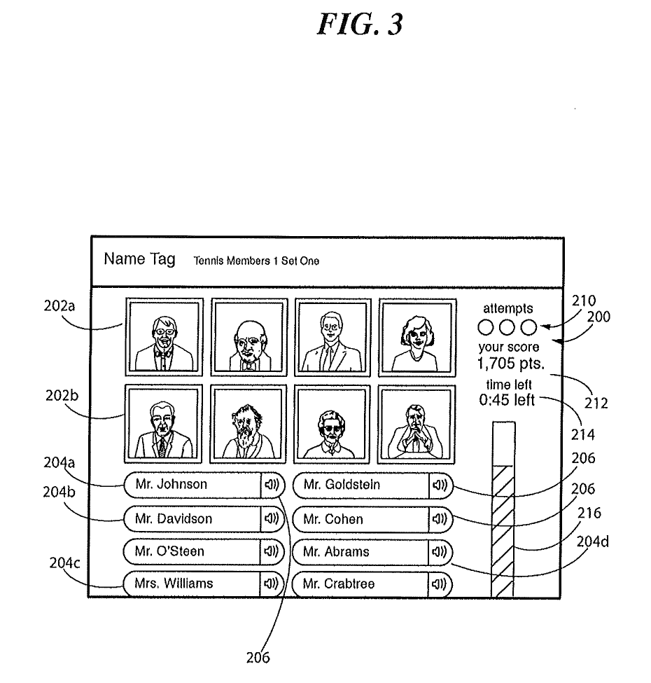

As seen in FIG. 3, the graphical user interface may include a screen 200 in which likeness information in the form of images 202 are caused to be displayed by server 12 at remote computer 16. Two or more names 204 are also displayed. Pronunciations 206 may be recorded and provided by server 12 to be activated at computer 16. In this embodiment, in step 56, a user 14, such as an employee in training, may select a photograph such as photograph 202a and then select a name such as Mr. Abrams 204e to indicate the name “Mr. Abrams” belongs to photograph 202a. This selected information is transmitted to server 12 which may provide an indicator to user 16 that the match is correct or incorrect. In step 58, server 12 determines a score for user 16.

Step 54 through 58 may be repeated until a sufficient sample of responses is provided. A sufficient sample may be determined by the number of displays presented, the number of selections made, and/or a predetermined time interval. In a step 60, it is determined whether or not the number of correct answers is sufficient for the employee 14 to provide the level of service desired or if employee 14 is ready for another level of testing. By way of example, the first time through the process may be a learning mode to learn the names, while successive iterations may be a test mode to determine whether the employee is truly ready.

As seen in FIG. 4, the presentation of at least one likeness information with at least two or more member information data is one of design choice. Variance on the exercise may be provided to truly test the ability of employee 14 to recall the information, to make sure that they are not “gaming a system” or to add play value to the exercise. So by way of example, as seen in FIG. 4, a single identification information 204a, but a plurality of likeness information 202 is provided so that employee 14 must select the correct likeness information 202 corresponding to the sole name information 204a. Again, in step 58, server 12 determines whether the selection is correct and keeps a running score.

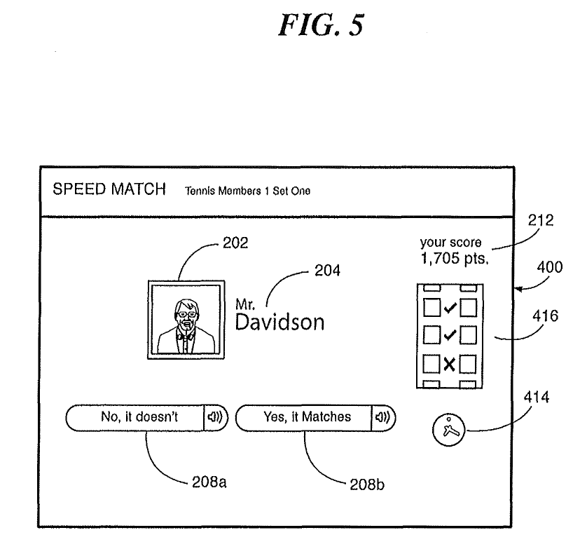

Another embodiment of the invention is shown in FIG. 5 in which a graphical user interface represented at screen 400 indicates a single likeness identification information 202 in the form of a photograph and a single identification information 204 shown as a name. User 14 at computer 16 selects one of two inputs 208a and 208b; 208a indicating that the information presented at computer 16 is not a match, and 208b indicating that it is a correct match.

It should be noted that each of the embodiments shown in FIG. 3-5 may be utilized to teach the recognition information to user 14 in a learning mode. However, each of these embodiments may be used as a practice mode in which score is kept, but not reported to a supervisor 34 at computer 30, or a testing mode in which this score is transmitted to supervisor 34 to determine whether employee 14 has in fact mastered the information.

Therefore, in a step 60, a determination is made whether or not a score calculated in step 58 is sufficient for user 14 to graduate to a next mode such as practice or test. If not, the process is returned to step 54 in which new displays are created by server 12 at computer 16. If the score is determined to be sufficient to correspond to having mastered a desired level of skill, then in a step 62, server 12 creates a new display transmitted and displayed at computer 16 which may be any of the types of embodiments of the graphical user interface represented by screen shots 200, 300 or 400. It should be noted that in these advanced levels, indicators may be provided. For example, in FIG. 3 in a timed process, a first indicator 210 may indicate how many attempts at the correct match have been tried. A current score indicator 212 may indicate to user 14 their current score to gauge how well they are doing. In a timed embodiment, a count down clock 214 may be displayed either as a numerical clock, as a descending bar 216 or the like. Furthermore, bar 216 may represent anything from percentage correct to raw score in an alternative embodiment. Alternatively, as shown in graphical interface 400, the clock 214 may be shown as an analog clock 414 and attempts, as well as correct answer percentage, may be graphically represented as a wheel or check marked tower 416.

The operation for test mode or practice mode is similar to that of steps 52-60. In a step 62, server 12 provides a graphical user interface display at computer 16. In step 64, server 12 creates the graphical user interface by providing likeness information 202, identification information 206 as a function of those members of the first group of individuals who will be provided a service by service provider such as user 14. In a step 64, user 14 utilizes the graphical user interface at a computer 16 to input appropriate matches between likeness information 202 and identification information 204. Steps 62 and 64 are repeated either for a predetermined number of iterations or for a predetermined time as determined by server 12. Server 12 tracks the number of correct matches and determines whether the number of correct matches exceeds a predetermined threshold of a minimum correct number of answers and a predetermined percentage corresponding to the desired service level for that employee 14. If the sample size or time duration corresponding to the current score is determined in step 66 to be insufficient, the process returns to step 62 for a repeat of the process. If the sample size or time duration score is sufficient, then a report is sent to supervisor 34 in step 68 that employee 14 is ready.

It should be noted that steps 62-64 are used to train and test user 14. By tracking score in the embodiments shown in FIGS. 3-5, the system provides play value which adds to the enjoyment of what is normally a tedious exercise providing encouragement and reinforcement to members of the second group to properly learn identities of the members of the first group. Furthermore, by tracking score, users 14 may be encouraged to compete amongst themselves to foster a sense of teamwork and pride in each other's work. By way of example, the top three scores may be posted to encourage others to score high for the associated name recognition. Each mode has its own purpose.

The learning mode utilizes repetition and the relocation of photos and the identifying names to reinforce the memorization of a small set of the members of the first group. In one embodiment, this repetition is extended to include larger and larger groups until service provider 14 demonstrates a strong grasp of the names of the members in the set even as additional members are added and repetition continues. At all times, supervisor 34 accessing server 12 from remote computer 30 may monitor the progress of service provider 14.

In a practice module, a series of games may be utilized on an individualized feedback basis to demonstrate how well a service provider 14 knows the names of members in a particular set. In this practice mode, the server provider obtains a fair assessment of how well they were performed in real life or in a competition mode without the worry of their score being recorded or reported to supervisor 34.

In a competition mode, a series of iterations of the process with rewarded points for accuracy and speed in name recognition may occur. The score becomes a function not only of the correct number, but the percentage of correct answers and/or the amount of time required to obtain that raw score or percentage; the less time required, the better the overall score. The scores may be recorded and reported to supervisor 34 while top scores are listed to be publicly seen, and if desired, awarded prizes. The competition may have a set time period in which to obtain a top score or a total team top score among several players after which prizes may be awarded incentivizing service providers to maintain a high level of accuracy or reducing the time period required to perform the identifications.

A testing module, which is not a game, may measure a service provider 14's name recognition ability. One question may be answered at a time and a final grade may be recorded and reported to supervisor 34, allowing supervisor 34 to monitor in the improvement of the service provider 14 at computer 30.

By providing information pertaining to at least one member of a first group across a distributed network to a member of a second group and utilizing a graphical user interface to identify information about the member of the first group and provide score feedback, a robust, flexible system which encourages service providers to learn identification information about the population to whom they will provide services is provided. Selecting the information to be sent to the server provider as a function of the nature of the service to be provided to the first group, further facilitates mastery of the information by self selecting a subgroup of the members of the first group, making it easier for the service provider to learn the necessary information.

It should be understood that modifications may be made to the described preferred embodiments of the invention by those skilled in the art. Therefore, it is intended that all matters in the foregoing description as shown in the accompanying drawings may be interpreted as illustrative and not in a limiting sense. Thus, the scope of the invention is determined by the appended claims.

What is claimed as new and desired to be protected by Letters Patent of the United States is:

1. A system for learning information associated with members of a first group comprising:
a server;
a database operatively connected to the server, name, and likeness information of a first group of individuals being stored in the server; identification information and service type of a second group of individuals being stored in the database; the server associating a respective one or more members of the first group of individuals with a respective one of the second group of individuals as a function of the service type of the respective individual of the second group of individuals; and
a remote computer in communication with the server, the server causing the display of the associated member of the first group at the remote computer, the remote computer having a graphical user interface, the server causing the likeness information of one or more associated members of the first group to be displayed at the remote computer and one or more identification information, at least one of the identification information corresponding to at least one of the likeness information of the associated member at the remote computer; the remote computer enabling a member of the second group to graphically match the identification information of at least one member of the first group to any one likeness information displayed at the remote computer.

2. The system of claim 1, wherein the server receives a match made at the remote computer as an input and determines whether the identification information corresponds to the likeness information and generates a score as a function of the match.

3. The system of claim 1, wherein the server generates an at least a second likeness information to be displayed at the remote computer.

4. The system of claim 1, wherein the server generates an at least second identification information displayed at the remote computer.

5. The system of claim 1, further comprising a third remote computer, the server sending the score to the third remote computer.

6. The system of claim 2, wherein the server transmits the score to the first remote computer for display at the first remote computer.

7. The system of claim 1, wherein a number of likeness information displayed at the remote computer does not equal a number of identification information displayed at the remote computer.
